(19) United States
(12) Patent Application Publication
(10) Pub. No.: US 2012/0150444 A1
(43) Pub. Date: Jun. 14, 2012

(54) APPARATUSES FOR MANAGING, DETERMINING, AND VERIFYING NAVIGATION ROUTE FOR MOBILE TERMINAL, NAVIGATION SERVICE PROVISION SYSTEM, AND METHOD OF MANAGING NAVIGATION ROUTE FOR MOBILE TERMINAL

(75) Inventors: Kang-Woon HONG, Seoul (KR); Hyun-Woo LEE, Daejeon-si (KR)

(73) Assignee: Electronics and Telecommunications Research Institute, Daejeon-si (KR)

(21) Appl. No.: 13/314,610

(22) Filed: Dec. 8, 2011

(30) Foreign Application Priority Data
Dec. 9, 2010 (KR) 10-2010-0125440

(51) Int. Cl. G01C 21/00

(52) U.S. Cl. 701/533; 701/400

(57) ABSTRACT

Apparatuses for managing, determining, and verifying a navigation route, a navigation service provision system, and a method of managing a navigation route are provided. The apparatus for managing a navigation route manages mapping information that maps one or more locations on the path of movement of a mobile terminal to information on one or more networks that are available for wireless communication at the locations. The apparatus for determining a navigation route selects an optimum navigation route from among a plurality of navigation routes into which a network access state of the mobile terminal on the path of movement of the mobile terminal is reflected, according to one or more preference rules. The apparatus for verifying a navigation route verifies the network access state of the mobile terminal on the path of movement of the mobile terminal.

### CROSS-REFERENCE TO RELATED APPLICATION(S)

This application claims the benefit under 35 U.S.C. §119(a) of Korean Patent Application No. 10-2010-0125440, filed on Dec. 9, 2010, in the Korean Intellectual Property Office, the entire disclosure of which is incorporated herein by reference for all purposes.

### BACKGROUND

1. Field

The following description relates to a technique of providing navigation services, and is more particularly, a technique of providing a navigation route of a mobile terminal.

2. Description of the Related Art

With recent developments in the development of various terminals and various network technologies, the types of services that can be provided to terminals via networks have diversified, ranging from broadcast and internet services to location-based services that are based on the mobility of mobile terminals, which is one of the most important characteristics of mobile terminals.

In general, location-based services are a variety of services that may be provided to terminals based on location information of the terminals, which is acquired using a communication network and location detection technology (LDT). For example, the location-based services not only include map services and location-based advertising services that are all based on location information of terminals but also include navigation services that provide directions from one place to another place via terminals that are installed in vehicles. With the widespread of network-based devices such as, for example, smart phones, more and more users demand seamless network access on the move, and thus, it is necessary to develop techniques to meet the demand.

### SUMMARY

The following description relates to techniques of managing, determining, and verifying a navigation route for a mobile terminal and a technique of providing navigation services.

In one general aspect, there is provided an apparatus for managing a navigation route, the apparatus including: a mapping information management unit configured to manage mapping information that maps information on one or more locations on a path of movement of a mobile terminal to information on one or more networks that are available for wireless communication at the locations; and a navigation route management unit configured to calculate one or more navigation routes for the mobile terminal using the mapping information and to manage the calculated navigation routes.

In another general aspect, there is provided an apparatus for determining a navigation route, the apparatus including: a navigation route collection unit configured to collect information on one or more navigation routes into which a network access state of a mobile terminal on a path of movement of the mobile terminal between a departure point and a destination point is reflected; and a navigation route determination unit configured to set one or more preference rules and select an optimum navigation route from the one or more navigation routes according to the preference rules.

In another general aspect, there is provided an apparatus for verifying a navigation route, the apparatus including: a navigation route verification unit configured to verify a network access state of a mobile terminal on a path of movement of a mobile terminal; and a mapping information provision unit configured to provide mapping information that maps a location of the mobile terminal at a time of access to a verified network to the verified network to an apparatus for managing a navigation route and allow the mapping information to be verified.

In another general aspect, there is provided a navigation service provision system, including: an apparatus for managing a navigation route, configured to calculate one or more navigation routes for a mobile terminal based on mapping information that maps one or more locations on a path of movement of the mobile terminal to information on one or more networks that are available for wireless communication at the locations and to manage the mapping information and the calculated navigation routes; an apparatus for determining a navigation route, configured to receive navigation route information from the apparatus for managing a navigation route and select an optimum navigation route from among a plurality of navigation routes that are set between a departure point and a destination point of the mobile terminal based on the navigation route information; and an apparatus for verifying a navigation route, configured to verify a network access state of the mobile terminal on the path of movement of the mobile terminal.

In another general aspect, there is provided a method of managing a navigation route, the method including: calculating one or more navigation routes for a mobile terminal based on mapping information that maps information on one or more locations on a path of movement of the mobile terminal to information on one or more networks that are available for wireless communication at the locations; and providing the calculated navigation routes to an apparatus for determining a navigation route.

Other features and aspects may be apparent from the following detailed description, the drawings, and the claims.

### BRIEF DESCRIPTION OF THE DRAWINGS

FIG. 1 is a diagram illustrating an example of a navigation service provision system.

FIG. 2 is a diagram illustrating an example of an apparatus for managing a navigation route.

FIG. 3 is a diagram illustrating an example of an apparatus for determining a navigation route.

FIG. 4 is a diagram illustrating an example of an apparatus for verifying a navigation route.

FIG. 5 is a flowchart illustrating an example of a method of calculating a navigation route, which is performed by the apparatus illustrated in FIG. 2.

FIG. 6 is a flowchart illustrating examples of methods of verifying and updating mapping information in a case in which the apparatus illustrated in FIG. 2 has a single structure.

FIG. 7 is a flowchart illustrating examples of methods of verifying and updating mapping information in a case in which the apparatus illustrated in FIG. 2 has a multi-structure.

FIG. 8 is a flowchart illustrating an example of a method of determining an optimum navigation route, which is performed by the apparatus illustrated in FIG. 3.

FIG. 9 is a flowchart illustrating an example of a method of processing verification of a navigation route, which is performed by the apparatus illustrated in FIG. 3.

FIG. 10 is a flowchart illustrating an example of a method of verifying a navigation route, which is performed by the apparatus illustrated in FIG. 4.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

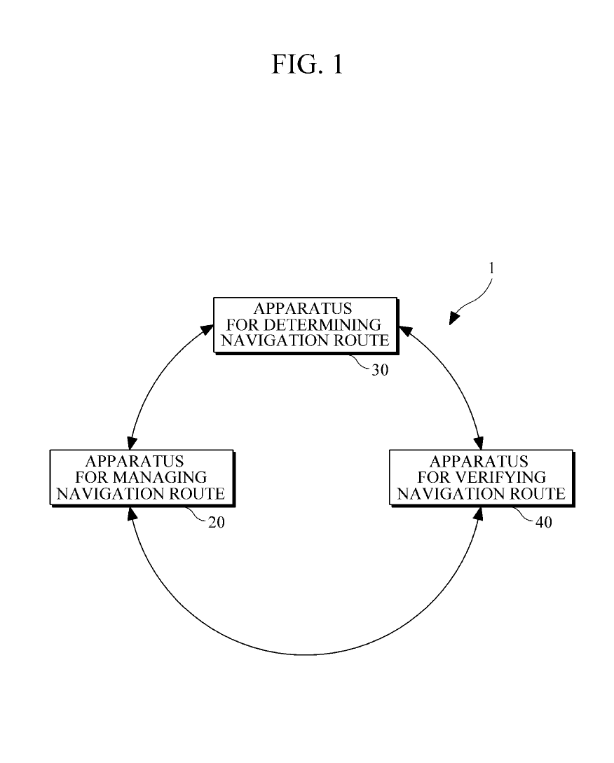

FIG. 1 illustrates an example of a system for providing navigation services. Referring to FIG. 1, system 1 includes an apparatus 20 for managing a navigation route, an apparatus 30 for determining a navigation route, and an apparatus 40 for verifying a navigation route.

The apparatuses 20, 30, and 40 may be installed in a single device or in different devices. For example, the apparatuses 20, 30, and 40 may be included in one of a mobile terminal (such as, for example, a mobile phone), a navigator for use in a vehicle that is equipped with a mobile terminal, or a remote navigation server.

The apparatus 20 may calculate one or more navigation routes for a mobile terminal using mapping information, and may manage the mapping information and navigation route information, which is information on the calculated navigation routes. The mapping information may be information that maps information on one or more locations on the path of movement of the mobile terminal to information on one or more networks that are available for wireless communication at the locations. The navigation route information may include information on a network access maintained distance-based navigation route between a departure point and a destination of the mobile terminal, information on a bandwidth-based navigation route between the departure point and the destination, and information on a communication expense-based navigation route between the departure point and the destination.

In response to a request for a search for a navigation route being received from the apparatus 30, the apparatus 20 may search for and find one or more navigation routes for the mobile terminal and may provide the found navigation routes to the apparatus 30. In response to a request for an update of the mapping information being received from the apparatus 40, the apparatus 20 may update the mapping information, and may provide the updated mapping information to the apparatus 40.

The apparatus 30 may be provided with the navigation route information by the apparatus 20, and may select an optimum navigation route from among a plurality of navigation routes that are set between the departure point and the destination according to a predefined set of preference rules. In this example, the apparatus 30 may receive information on the departure point and the destination from an input unit (not shown), and may output the selected optimum navigation route via an output unit (not shown). The apparatus 30 may issue a request for a verification of the mapping information to the apparatus 40, and may receive mapping information verification results from the apparatus 40.

The apparatus 40 may verify a network access state for each navigation route for the mobile terminal. In response to a request for a verification of the mapping information being received from the apparatus 30, the apparatus 40 may request the apparatus 20 to verify the mapping information, may receive the results of verification of the mapping information from the apparatus 20, and may provide the received mapping information verification results to the apparatus 30.

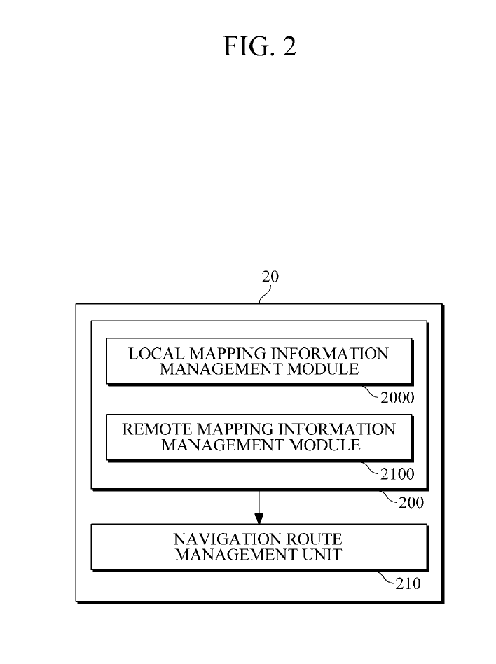

FIG. 2 illustrates an example of the apparatus 20.

Referring to FIG. 2, the apparatus 20 includes a mapping information management unit 200 and a navigation route management unit 210.

The mapping information management unit 200 may manage mapping information that maps information on one or more locations on the path of movement of a mobile terminal to information on one or more networks that are available for wireless communication at the locations. For example, the mapping information may include information that maps a particular location to one or more pieces of network information. In another example, the mapping information may include information that provides one or more locations that are mapped to particular network information as a list or an image in which the one or more locations to which the particular network information is mapped are marked in an area that is defined by a central location and a predetermined radial distance from the central location. In yet another example, the mapping information may include information that maps one or more pieces of network information to a particular navigation route. In these examples, the network information may include at least one of access type information, supported moving speed information, signal coverage information, base station information, bandwidth information, and cost information.

The navigation route management unit 210 may calculate one or more navigation routes for the mobile terminal based on the mapping information, and may manage the calculated navigation routes. The navigation route management unit 210 may provide navigation route information on the calculated navigation routes to the apparatus 30 as navigation route information. The navigation route management unit 210 may calculate a network access maintained distance-based navigation route between a departure point and a destination of the mobile terminal, a bandwidth-based navigation route between the departure point and the destination, and a communication expense-based navigation route between the departure point and the destination based on the mapping information.

For example, the navigation route management unit 210 may calculate the network access maintained distance-based navigation route by calculating the ratio of the combined length of parts of each navigation route on which network access is maintained to the total length of a corresponding navigation route and classifying the results of the calculation. For example, the navigation route management unit 210 may calculate the bandwidth-based navigation route by calculating an average of bandwidths that are supported on parts of each navigation route where network access is maintained and classifying the results of the calculation. For example, the navigation route management unit 210 may calculate the communication expense-based navigation route by calculating an average of communication expenses that may be incurred on parts of each navigation route where network access is maintained and classifying the results of the calculation.

The mapping information management unit 200 may include a local mapping information management module 2000 and a remote mapping information management module 2100. The local mapping information management module 2000 may manage a copy of mapping information, and the remote mapping information management module 2100 may manage the original mapping information. The remote mapping information management module 2100 may receive mapping information from the local mapping information management module 2000, may compare the received mapping information with the original mapping information, and may verify the received mapping information or update the original mapping information based on the results of the comparison.

For example, the local mapping information management module 2000 may receive a mapping information copy and mapping information update request message from the apparatus 20, and may store the mapping information copy. The local mapping information management module 2000 may provide the mapping information copy to the remote mapping information management module 2100. The remote mapping information management module 2100 may compare the mapping information copy with the original mapping information. In response to the results of the comparison indicating that the mapping information copy does not match the original mapping information, the remote mapping information management module 2100 may update the original mapping information with the mapping information copy.

In another example, the local mapping information management module 2000 may receive a mapping information copy and a mapping information verification request message from the apparatus 40, and may store the mapping information copy. The local mapping information management module 2000 may provide the mapping information copy to the remote mapping information management module 2100. The remote mapping information management module 2100 may compare the mapping information copy with the original mapping information, and may transmit the results of the comparison to the apparatus 40 via the local mapping information management module 2000.

In the example illustrated in FIG. 2, it is possible to easily extract navigation route information that indicates one or more navigation routes on which a mobile terminal can be connected to a network by managing mapping information that maps the location of the mobile terminal and the network. In addition, by using the mapping information, it is possible to calculate one or more navigation routes into which the length of parts of the path between a departure point and a destination where network access is maintained, bandwidths that are supported on the path between the departure point and the destination, and communication expenses that may be incurred on the path between the departure point and the destination are reflected. Moreover, it is possible to facilitate the update and verification of the mapping information through a remote or local management of the mapping information. Furthermore, it is possible to it is possible to seamlessly provide navigation services to a mobile terminal regardless of whether the mobile terminal is handed over from one network system to another network system or resides in a shadow area.

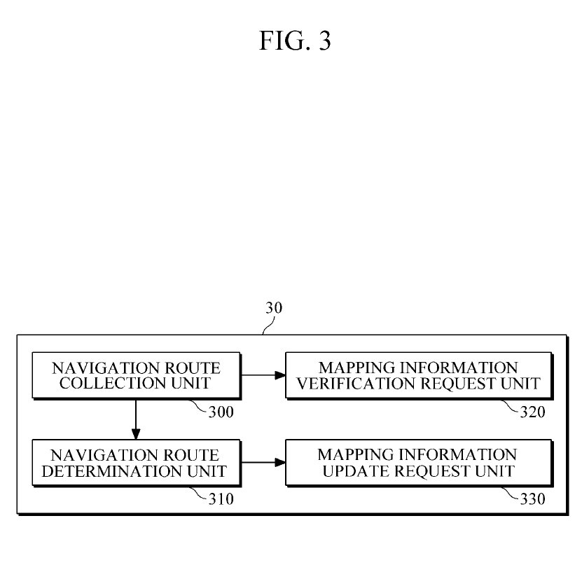

FIG. 3 illustrates an example of the apparatus 30.

Referring to FIG. 3, the apparatus 30 includes a navigation route collection unit 300 and a navigation route determination unit 310.

The navigation route collection unit 300 may collect navigation route information into which a network access state of a mobile terminal on the path of movement of the mobile terminal is reflected. The navigation route information may include information on a network access maintained distance-based navigation route between a departure point and a destination of the mobile terminal, information on a bandwidth-based navigation route between the departure point and the destination, and information on a communication expense-based navigation route between the departure point and the destination. The navigation route information may be information on one or more navigation routes that are calculated by the apparatus 20 based on mapping information. The navigation route collection unit 300 may issue a request for the navigation route information to the apparatus 20, and may thus be provided with the navigation route information. The mapping information may be information that maps information on one or more locations on the path of movement of the mobile terminal to information on one or more networks that are available for wireless communication at the locations.

The navigation route determination unit 310 may set a set of preference rules, and may determine an optimum navigation route between the departure point and the destination according to the set of preference rules. For example, the navigation route determination unit 310 may determine the set of preference rules and set priorities between the set of preference rules by reflecting at least one of the distance travelled between the departure point and the destination while maintaining network access, whether network access is maintained along each navigation route, bandwidths that are supported along each navigation route, and communication expenses that may be incurred on each navigation route.

The apparatus 30 may also include a mapping information verification request unit 320 and a mapping information update request unit 330. The mapping information verification request unit 320 may issue a request for a verification of a network access state of the mobile terminal on the path of movement of the mobile terminal to the apparatus 40. The mapping information update request unit 330 may provide the location of the mobile terminal and mapping information to the apparatus 20, and may issue a request for an update of the mapping information to the apparatus 20.

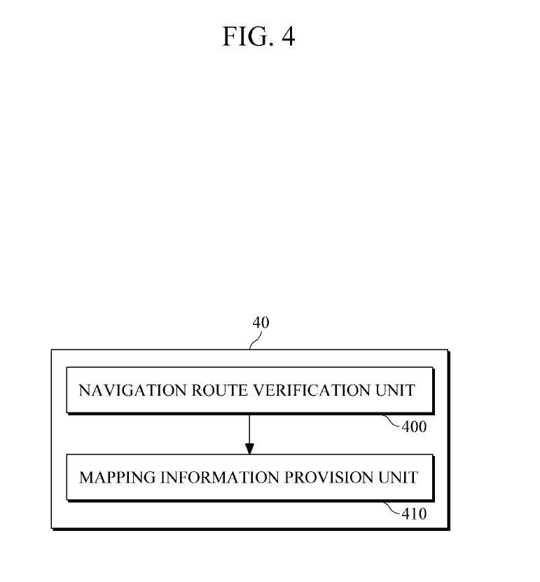

FIG. 4 illustrates an example of the apparatus 40.

Referring to FIG. 4, the apparatus 40 includes a navigation route verification unit 400 and a mapping information provision unit 410.

The navigation route verification unit 400 may verify a network access state of a mobile terminal on the path of movement of the mobile terminal. For example, the navigation route verification unit 400 may verify the network access state of the mobile terminal on the path of movement of the mobile terminal using an interface that is separate from an interface for data communication.

In response to the mobile terminal accessing a verified network, the mapping information provision unit 410 may provide mapping information that maps the location of the mobile terminal at the time of access to the verified network to the verified network to the apparatus 20, and may allow the mapping information to be verified. For example, in response to a navigation route verification request message being received from the apparatus 30, the mapping information provision unit 410 may issue a request for a verification of mapping information to the apparatus 20, may allow mapping information to be verified, and may transmit a navigation route verification response message to the apparatus 30.

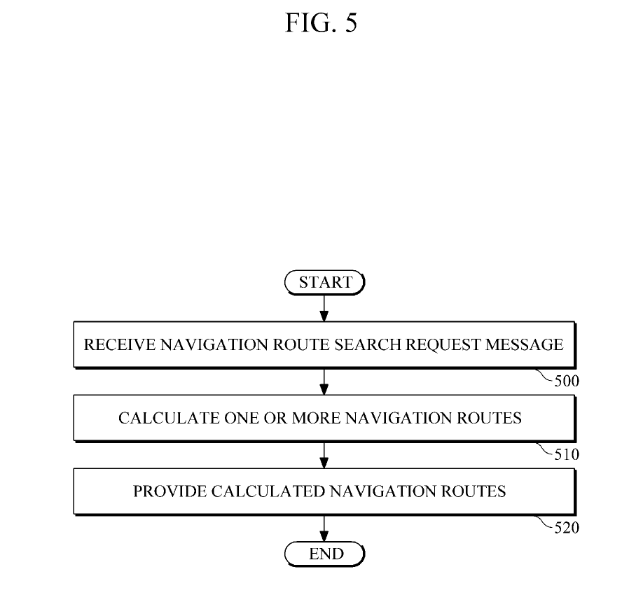

FIG. 5 illustrates a flowchart of an example of a method of calculating a navigation route, which is performed by the apparatus 20.

Referring to FIG. 5, in 500, the apparatus 20 may receive a navigation route search request message from the apparatus 30.

In 510, the apparatus 20 may calculate one or more navigation routes for a mobile terminal based on mapping information that maps information on one or more locations on the path of movement of the mobile terminal to information on one or more networks that are available for wireless communication at the locations. For example, the apparatus 20 may calculate a network access maintained distance-based navigation route between a departure point and a destination of the mobile terminal, a bandwidth-based navigation route between the departure point and the destination, and a communication expense-based navigation route between the departure point and the destination based on the mapping information.

For example, the apparatus 20 may calculate the network access maintained distance-based navigation route by calculating the ratio of the combined length of parts of each navigation route on which network access is maintained to the total length of a corresponding navigation route and classifying the results of the calculation. For example, the apparatus 20 may calculate the bandwidth-based navigation route by calculating an average of bandwidths that are supported on each navigation route where network access is maintained and classifying the results of the calculation. For example, the apparatus 20 may calculate the communication expense-based navigation route by calculating an average of communication expenses that may be incurred on parts of each navigation route where network access is maintained and classifying the results of the calculation.

The apparatus 20 may provide the calculated navigation routes to the apparatus 30.

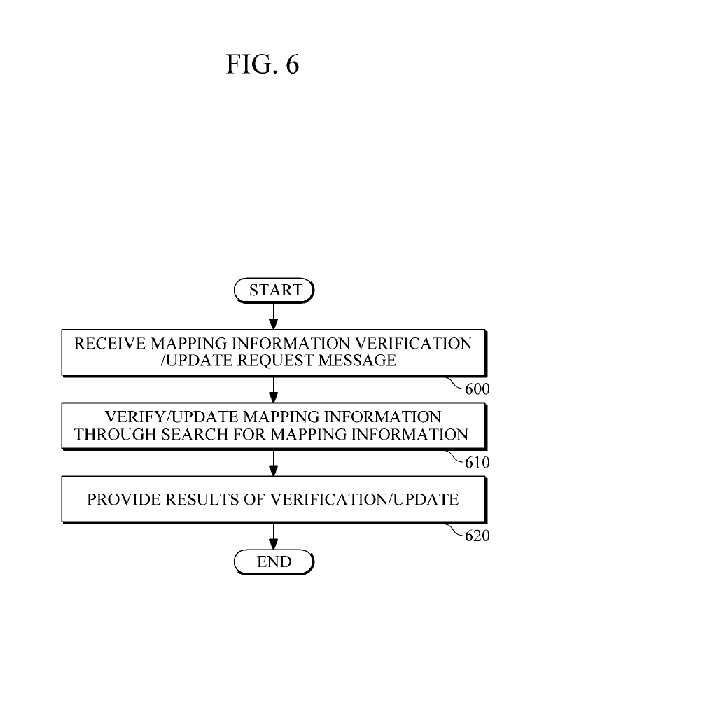

FIG. 6 illustrates examples of methods of verifying and updating mapping information in a case in which the apparatus 20 has a single structure.

An example of verifying mapping information is described with reference to FIG. 6.

Referring to FIG. 6, in 600, the apparatus 20 may receive mapping information and a mapping information verification request message from the apparatus 40.

In 610, the apparatus 20 may search for and find previously-stored mapping information and may verify the received mapping information based on the found mapping information. In 620, the apparatus 20 may provide the results of the verification of the received mapping information to the apparatus 40.

An example of updating mapping information is described with reference to FIG. 6.

Referring to FIG. 6, in 600, the apparatus 20 may receive mapping information and a mapping information update request message from the apparatus 30.

In 610, the apparatus 20 may search for and find previously-stored mapping information, may compare the received mapping information with the found mapping information, and may update the found mapping information with the received mapping information in response to the results of the comparison indicating that the found mapping information does not match the received mapping information. In 630, the apparatus 20 may provide the results of the update of the found mapping information to the apparatus 30.

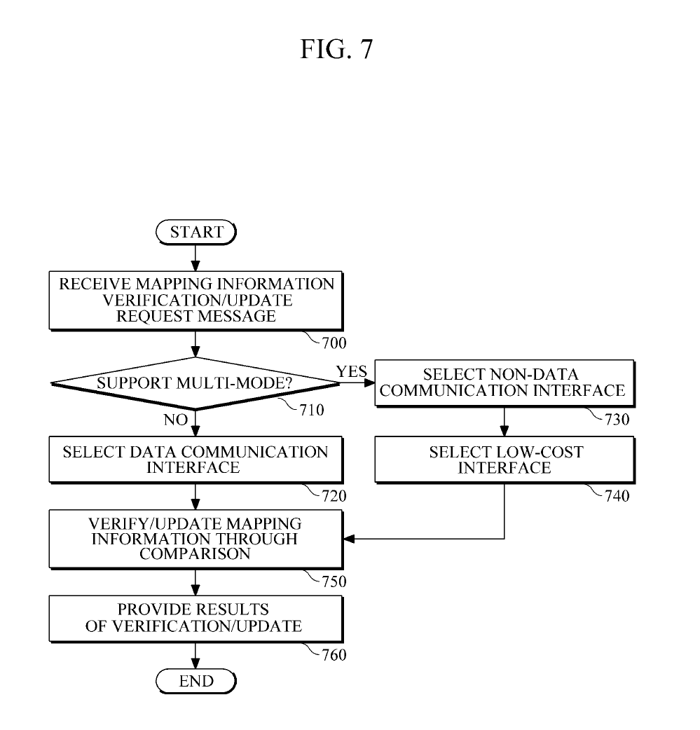

FIG. 7 illustrates examples of methods of verifying and updating mapping information in a case in which the apparatus 20 has a multi-structure and is thus capable of managing mapping information both locally and remotely.

Another example of verifying mapping information is described with reference to FIG. 7.

Referring to FIG. 7, in 7000, the apparatus 20 may receive mapping information and a mapping information verification request message from the apparatus 40.

In 710, a determination may be made as to whether a mobile terminal supports a multi-mode and a multi-interface. In 720, in response to the mobile terminal being determined not to support the multi-mode and the multi-interface, a data communication interface may be selected. In 730 and 740, in response to the mobile terminal being determined to support the multi-mode and the multi-interface, a non-data communication interface and a low-cost interface may be selected. For example, a network verification interface that is separate from the data is communication interface may be selected.

In 750, the apparatus 20 may compare the received mapping information with previously-stored original mapping information, and may verify the received mapping information. For example, referring to FIG. 2, the local mapping information management module 2000 may receive mapping information from the apparatus 40, may manage the mapping information, and may transmit the mapping information to the remote mapping information management module 2100. The remote mapping information management module 2100 may compare the mapping information with original mapping information, and may verify the mapping information. In 760, the remote mapping information management module 2100 may provide the results of the verification to the apparatus 40 via the local mapping information management module 2000.

Another example of updating mapping information is described with reference to FIG. 7.

Referring to FIG. 7, in 700, the apparatus 20 may receive mapping information and a mapping information update request message from the apparatus 30.

In 710, a determination may be made as to whether a mobile terminal supports a multi-mode and a multi-interface. In 720, in response to the mobile terminal being determined not to support the multi-mode and the multi-interface, a data communication interface may be selected. In 730 and 740, in response to the mobile terminal being determined to support the multi-mode and the multi-interface, a non-data communication interface and a low-cost interface may be selected. For example, a network verification interface that is separate from the data communication interface may be selected.

In 750, the apparatus 20 may compare the received mapping information with previously-stored original mapping information, and may update the original mapping information with the received mapping information based on the results of the comparison. For example, referring to FIG. 2, the local mapping information management module 2000 may receive mapping information from the apparatus 30, may manage the mapping information, and may transmit the mapping information. The remote mapping information management module 2100 may compare the mapping information with original mapping information. In response to the results of the comparison indicating that the mapping information does not match the original mapping information, the remote mapping information management module 2100 may update the original mapping information. In 760, the remote mapping information management module 2100 may provide the results of the update to the apparatus 30 via the local mapping information management module 2000.

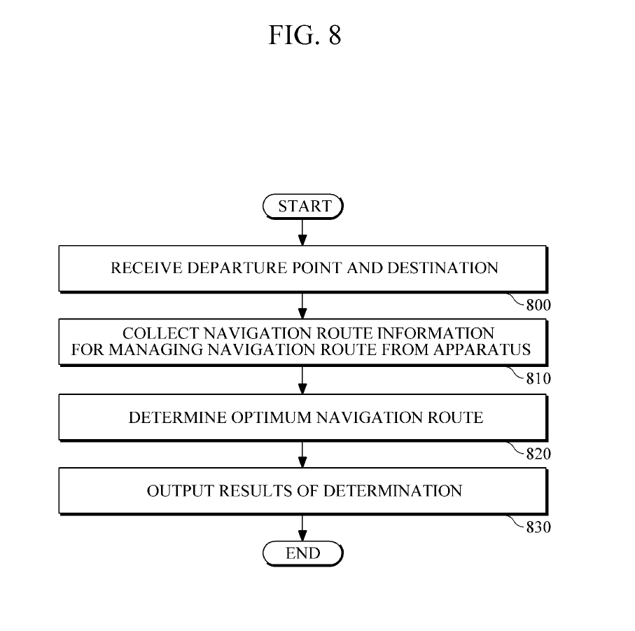

FIG. 8 illustrates an example of a method of determining an optimum navigation route, which is performed by the apparatus 30.

Referring to FIG. 3, in 800, the apparatus 30 may receive information on a departure point and a destination of a mobile terminal.

In 810, the apparatus 30 may request the apparatus 20 to search for and find one or more navigation routes for the mobile terminal and may receive navigation route information from the apparatus 20. The navigation route information may include information on a network access maintained distance-based navigation route between a departure point and a destination of the mobile terminal, information on a bandwidth-based navigation route between the departure point and the destination, and information on a communication expense-based navigation route between the departure point and the destination. The navigation route information may be information on one or more navigation routes that are calculated by the apparatus 20 based on mapping information.

In 820, the apparatus 30 may select an optimum navigation route from among a plurality of navigation routes that are set between the departure point and the destination according to a set of preference rules.

For example, the apparatus 30 may determine the set of preference rules and set priorities between the set of preference rules by reflecting at least one of the length of each navigation route between the departure point and the destination, whether network access is maintained along each navigation route, bandwidths that are supported along each navigation route, and communication expenses that may be incurred on each navigation route. The apparatus 30 may select one of the plurality of navigation routes as the optimum navigation route according to the set of preference rules. In another example, the apparatus 30 may output a list of one or more navigation routes via a display unit, and may allow a user to select an optimum navigation route from the list.

In 830, the apparatus 30 may output the selected optimum navigation route via a display unit.

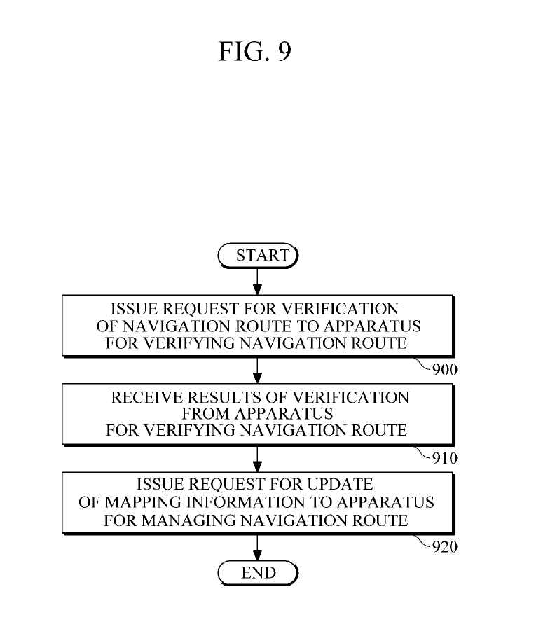

FIG. 9 illustrates an example of a method of processing verification of a navigation route, which is performed by the apparatus 30.

Referring to FIG. 9, in 900, the apparatus 30 may issue a request for a verification of a navigation route to the apparatus 40. In 910, the apparatus 30 may receive the results of verification of the navigation route from the apparatus 40. For example, the apparatus 30 may allow the state of each network on the navigation route to be verified by the apparatus 40. In this example, the apparatus 30 may provide information on one or more networks on the navigation route to the apparatus 40 all together as a list or separately one after another to the apparatus 40.

In 920, the apparatus 30 may transmit mapping information that maps the location of the mobile terminal at the time of access to a network to the network to the apparatus 20, and may issue a request for an update of mapping information present in the apparatus 20.

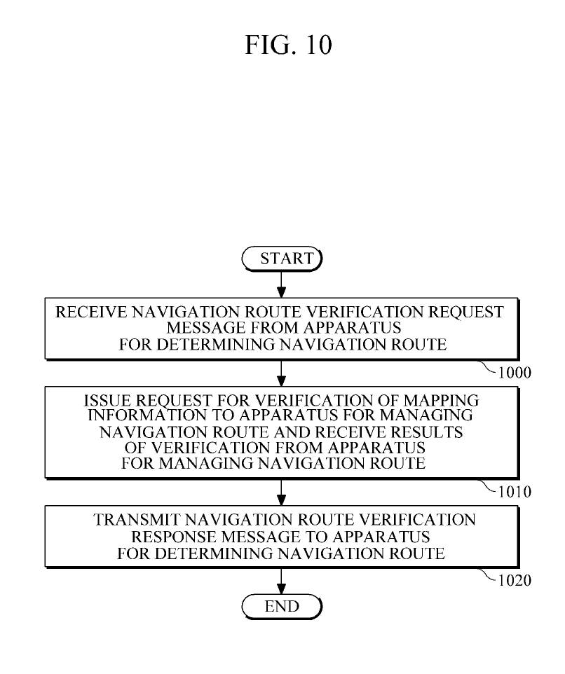

FIG. 10 illustrates an example of a method of verifying a navigation route, which is performed by the apparatus 40.

Referring to FIG. 10, in 1000, the apparatus 40 may receive a navigation route verification request message from the apparatus 30.

In 1010, the apparatus 40 may issue a request for a verification of mapping information to the apparatus 20, and may allow the mapping information to be verified by the apparatus 20. The apparatus 40 may verify the state of a predetermined network that is accessed by a mobile terminal based on mapping information that maps the location of the mobile terminal to the predetermined network. For example, to verify the state of the predetermined network, the apparatus 40 may transmit the mapping information to the apparatus 20 to determine whether the mapping information matches original mapping information. In a case in which a plurality of pieces of information on a plurality of networks that are available on the path of movement of the mobile terminal are provided all together as a list via one or more base stations that are specified the plurality of pieces of information, the apparatus may use the plurality of pieces of information to perform pre-navigation route verification. On the other hand, in a case in which the plurality of pieces of information are provided one after another, the apparatus 40 may use the plurality of information to perform dynamic navigation route verification.

In a case in which the mobile terminal provides a plurality of communication interfaces, the apparatus 40 may use both a data communication interface and a network verification network at the same time. For example, if the mobile terminal is a multi-mode mobile terminal, the state of a network may be verified using a Code Division Multiple Access (CDMA) interface that provides low bandwidths at high cost, and a WiBro interface that provides relatively high bandwidths may be used for communicating data.

In 1020, the apparatus 40 may transmit a navigation route verification response message to the apparatus 30.

As described above, it is possible to satisfy various demands from a user who wishes to continue to be connected to a network while moving from one place to another place.

That is, it is possible to provide a user with a navigation route on which network access is available by managing mapping information that maps information on one or more locations on the path of movement of a mobile terminal to information on one or more networks that are available for wireless communication at the locations. In addition, it is possible to calculate one or more navigation routes using the mapping information in consideration of the length of parts of each navigation route on which network access is maintained, bandwidths that are supported along each navigation route, and communication expenses that may be incurred on each navigation route, and to provide the calculated navigation routes to a user. Moreover, it is possible to facilitate the update and verification of the mapping information through a local or remote management of the mapping information.

Moreover, it is possible to it is possible to seamlessly provide navigation services to a mobile terminal regardless of whether the mobile terminal is handed over from one network system to another network system or resides in a shadow area.

Furthermore, it is possible to effectively select an optimum navigation route from among a plurality of navigation routes that are set between a departure point and a destination of a mobile terminal by using an apparatus for determining a navigation route. That is, it is possible to provide an optimum navigation route for a mobile terminal using a set of preference rules that are set in consideration of the length of each navigation route, whether network access is maintained on each navigation route, bandwidths that are supported on each navigation route, and/or communication expenses that may be incurred on each navigation route. In addition, it is possible to effectively verify a network access state of a mobile terminal on the path of movement of the mobile terminal.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for managing a navigation route, the apparatus comprising:
a mapping information management unit configured to manage mapping information that maps information on one or more locations on a path of movement of a mobile terminal to information on one or more networks that are available for wireless communication at the locations; and
a navigation route management unit configured to calculate one or more navigation routes for the mobile terminal using the mapping information and to manage the calculated navigation routes.

2. The apparatus of claim 1, wherein the mapping information comprises information that maps a particular location to one or more pieces of network information, information that provides one or more locations that are mapped to particular network information as a list or an image in which the one or more locations to which the particular network information is mapped are marked in an area that is defined by a central location and a predetermined radial distance from the central location, and information that maps one or more pieces of network information to a particular navigation route.

3. The apparatus of claim 1, wherein the network information comprises at least one of network access type information, supported moving speed information, signal coverage information, base station information, supported bandwidth information, and communication expense information.

4. The apparatus of claim 1, wherein the navigation route management unit is further configured to calculate a network access maintained distance-based navigation route between a departure point and a destination point of the mobile terminal, a bandwidth-based navigation route between the departure point and the destination point, and a communication expense-based navigation route between the departure point and the destination point based on the mapping information.

5. The apparatus of claim 4, wherein the navigation route management unit is further configured to calculate the network access maintained distance-based navigation route by calculating a ratio of a combined length of parts of each navigation route to a total length of a corresponding navigation route and classifying the results of the calculation.

6. The apparatus of claim 4, wherein the navigation route management unit is further configured to calculate the bandwidth-based navigation route by calculating an average of bandwidths that are supported on parts of each navigation route on which network access is maintained and classifying the results of the calculation.

7. The apparatus of claim 4, wherein the navigation route management unit is further configured to calculate the communication expense-based navigation route by calculating an average of communication expenses that may be incurred on parts of each navigation route where network access is maintained and classifying the results of the calculation.

8. The apparatus of claim 1, wherein the mapping information management unit comprises:
a local mapping information management module configured to manage a copy of the mapping information; and
a remote mapping information management module configured to manage the original mapping information, wherein, in response to mapping information being received from the local mapping information management module, the remote mapping information compares the received mapping information with the original mapping information and verifies the received mapping information or updates the original mapping information based on the results of the comparison.

9. The apparatus of claim 8, wherein the remote mapping information management module is further configured to, in response to the results of the comparison indicating that the received mapping information does not match the original mapping information, update the copy of the mapping information and the original mapping information with the received mapping information and to provide the results of the mapping information to an apparatus for verifying a navigation route via the local mapping information management module.

10. The apparatus of claim 1, wherein the navigation route management unit is further configured to provide information on the calculated navigation routes to an apparatus for determining a navigation route and the mapping information management unit is further configured to be provided with results of verification of a network access state of the mobile terminal on the path of movement of the mobile terminal by an apparatus for verifying a navigation route and to update the mapping information based on the verification results.

11. An apparatus for determining a navigation route, the apparatus comprising:
a navigation route collection unit configured to collect information on one or more navigation routes into which a network access state of a mobile terminal on a path of movement of the mobile terminal between a departure point and a destination point is reflected; and
a navigation route determination unit configured to set one or more preference rules and select an optimum navigation route from the one or more navigation routes according to the preference rules.

12. The apparatus of claim 11, wherein the navigation route determination unit is further configured to set the preference rules and set priorities between the preference rules by reflecting at least one of a distance between the departure point and the destination point, whether network access is maintained, bandwidths that are supported, and communication expenses that are to be incurred.

13. The apparatus of claim 11, further comprising:
is a mapping information verification request unit configured to allow network access state information that is collected by the navigation route collection unit to be verified by an apparatus for verifying a navigation route; and
a mapping information update request unit configured to provide mapping information that maps information on a location of the mobile terminal and a network that is accessed by the mobile terminal to an apparatus for managing a navigation route and to issue a request for an update of the mapping information to the apparatus for managing a navigation route.

14. An apparatus for verifying a navigation route, the apparatus comprising:
a navigation route verification unit configured to verify a network access state of a mobile terminal on a path of movement of a mobile terminal; and
a mapping information provision unit configured to provide mapping information that maps a location of the mobile terminal at a time of access to a verified network to the verified network to an apparatus for managing a navigation route and allow the mapping information to be verified.

15. The apparatus of claim 14, wherein the navigation route verification unit is further configured to verify the network access state of the mobile terminal using a network verification interface that is separate from a data communication interface.

16. A navigation service provision system, comprising:
an apparatus for managing a navigation route, configured to calculate one or more navigation routes for a mobile terminal based on mapping information that maps one or more locations on a path of movement of the mobile terminal to information on one or more networks that are available for wireless communication at the locations and to manage the mapping information and the calculated navigation routes;
an apparatus for determining a navigation route, configured to receive navigation route information from the apparatus for managing a navigation route and select an optimum navigation route from among a plurality of navigation routes that are set between a departure point and a destination point of the mobile terminal based on the navigation route information; and
an apparatus for verifying a navigation route, configured to verify a network access state of the mobile terminal on the path of movement of the mobile terminal.

17. A method of managing a navigation route, the method comprising:
Calculating one or more navigation routes for a mobile terminal based on mapping information that maps information on one or more locations on a path of movement of the mobile terminal to information on one or more networks that are available for wireless communication at the locations; and
providing the calculated navigation routes to an apparatus for determining a navigation route.

18. The method of claim 17, wherein the calculating the one or more navigation routes comprises calculating a network access maintained distance-based navigation route between a departure point and a destination point of the mobile terminal, a bandwidth-based navigation route between the departure point and the destination, and a communication expense-based navigation route between the departure point and the destination based on the mapping information.

19. The method of claim 17, further comprising:
verifying the mapping information by comparing the mapping information with previously-stored original mapping information; and
in response to the results of the comparison indicating that the mapping information does not match the original mapping information, updating the original mapping information with the mapping information.
